(19) United States
(12) Patent Application Publication
(10) Pub. No.: US 2014/0308441 A1
(43) Pub. Date: Oct. 16, 2014

(54) METHOD OF MANUFACTURING RARE-EARTH MAGNETS

(71) Applicants: Tetsuya Shoji, Toyota-shi (JP); Shinya Omura, Aichi-gun (JP); Motoki Hiraoka, Toyota-shi (JP)

(72) Inventors: Tetsuya Shoji, Toyota-shi (JP); Shinya Omura, Aichi-gun (JP); Motoki Hiraoka, Toyota-shi (JP)

(73) Assignee: TOYOTA JIDOSHA KABUSHIKI KAISHA, Toyota-shi, Aichi-ken (JP)

(21) Appl. No.: 14/355,389

(22) PCT Filed: Nov. 7, 2012
(86) PCT No.: PCT/IB2012/002248

§ 371 Date: Apr. 30, 2014

(30) Foreign Application Priority Data
Nov. 14, 2011 (JP) 2011-248923

(51) Int. Cl. H01F 41/02

(52) U.S. Cl. CPC H01F 41/02
USPC 427/129

(57) ABSTRACT

A method of manufacturing rare-earth magnets includes, a first step of producing a compact C by subjecting a sintered body S, which is formed of a RE—Fe—B main phase MP having a nanocrystalline structure (where RE is at least one of neodymium and praseodymium) and a grain boundary phase BP of an RE—X alloy (where X is a metal element) located around the main phase, to hot plastic processing that imparts anisotropy; and a second step of producing a rare-earth magnet RM by melting a RE—Y—Z alloy which increases the coercive force of the compact C (where Y is a transition metal element, and Z is a heavy rare-earth element), together with the grain boundary phase BP, and liquid-phase infiltrating the RE—Y—Z alloy melt from a surface of the compact C.

### BACKGROUND OF THE INVENTION

1. Field of the Invention

The invention relates to a method of manufacturing rare-earth magnets.

2. Description of Related Art

Rare-earth magnets which use rare-earth elements such as lanthanoids are also called permanent magnets. Applications include motors in hard disk drives and magnetic resonance imaging (MRI) scanners, as well as drive motors in hybrid vehicles and electric cars.

Remanent magnetization (remanent magnetic flux density) and coercive force may be cited as indicators of the performance of these rare-earth magnets. The rise in heat generation associated with the miniaturization and trend toward higher current density in motors has prompted a greater desire for heat resistance also in the rare-earth magnets that are, used. How to maintain the coercive strength of a magnet under high-temperature use is thus a major topic of research today in this technical field. In the case of Nd—Fe—B-based magnets, for example, which are one type of rare-earth magnet commonly used in drive motors for vehicles, efforts are being made to increase their coercive force by, for example, reducing the size of the crystal grains, using alloys having a high neodymium content, and adding the heavy rare-earth elements like dysprosium and terbium, which have high coercive force performances.

Rare-earth magnets include common sintered magnets in which the scale of the grains (main phase) making up the microstructure is about 3 μm to 5 and nanocrystalline magnets in which the size of the crystal grains has been reduced to a nanoscale level of about 50 nm to 300 nm. Especially noteworthy among these at present are nanocrystalline magnets in which the amount of high-cost heavy rare-earth elements is reduced (or eliminated) while striving to decrease the size of the crystal grains.

Of the heavy rare-earth elements, dysprosium, which is used in large quantities, is discussed here. Because reserves of dysprosium occur predominantly in China and because China has placed restrictions on the production and export of dysprosium and other rare metals, the commodity price of dysprosium has been rising rapidly in fiscal 2011. Hence, one key challenge has been to develop low-dysprosium magnets which ensure coercive force performance while reducing the amount of dysprosium, and dysprosium-free magnets which ensure coercive force performance without the use of any dysprosium. This is one major factor that has increased the degree of attention being paid to nanocrystalline magnets.

A method of manufacturing nanocrystalline magnets is summarized. A Nd—Fe—B-based metal melt, for example, is rapidly solidified, and the resulting nanosize fine powder is pressure sintered, thereby producing a sintered body. Hot plastic working is carried out on the sintered body to impart magnetic anisotropy, producing a compact.

Rare-earth magnets composed of a nanocrystalline magnet are produced by using various techniques to include in this compact a heavy rare-earth element having a high coercive force performance. Examples include the production methods disclosed in Japanese Patent Application Publication No. 2011-035001 (JP-2011-035001 A) and Japanese Patent Application Publication No. 2010-114200 (JP-2010-114200 A).

First, JP-2011-035001 A discloses a production process which vaporizes an evaporation material containing at least one of dysprosium and terbium onto a hot plastic-worked compact, thereby inducing grain boundary diffusion from the surface of the compact.

An essential condition in this production process is high-temperature treatment at about 850° C. to 1050° C. in the evaporation material vaporization step. This temperature range was prescribed to enhance the remanent coercive force density and to suppress excessively rapid crystal grain growth.

However, when heat treatment is carried out in a temperature range as high as about 850° C. to 1050° C., coarsening of the crystal grains occurs, as a result of which there is a greater likelihood that the coercive force will decrease. That is, even though dysprosium and terbium are grain boundary diffused, it becomes impossible to sufficiently increase the coercive force.

On the other hand, JP-2010-114200 A discloses a production process in which at least one element from among dysprosium (Dy), terbium (Tb) and holmium (Ho), or an alloy of at least one element from among copper (Cu), aluminum (Al), gallium (Ga), germanium (Ge), tin (Sn), indium (In), silicon (Si), phosphorus (P) and cobalt (Co), is brought into contact with the surface of a rare-earth magnet and heat-treated to effect grain boundary diffusion in such a way that the grain size does not exceed 1 μm.

It is mentioned here in JP-2010-114200 A that, when the temperature during heat treatment is in the range of 500° C. to 800° C., an excellent balance is achieved between the diffusion effect by Dy, etc. to the crystal grain boundary phase and the crystal grain coarsening suppression effect by heat treatment, making it easier to obtain a rare-earth magnet having a high coercive force. Moreover, in various examples thereof, the use of a Dy—Cu alloy and heat-treatment at 500° C. to 900° C. are mentioned. However, even in the various examples described, because the melting point of a typical 85Dy-15Cu alloy is about 1100° C., high-temperature treatment at about 1000° C. or above is required in order to have this metal melt diffuse and infiltrate into a rare-earth magnet. As a result, it is impossible to suppress a coarsening of the crystal grains.

Therefore, because the alloy in heat treatment within the range of 500° C. to 800° C. in JP-2010-114200 A is a solid phase and the Dy—Cu alloy or the like is diffused within the rare-earth magnet by solid phase diffusion, it can readily be appreciated that such diffusion takes time.

This invention was conceived in light of the fact that coarsening of the crystal grains occurs in the high-temperature atmosphere when diffusing a modified alloy containing a high-melting heavy rare-earth element into the grain boundary phase and the fact that solid-phase diffusion of this modified alloy takes time.

### SUMMARY OF THE INVENTION

The invention provides a method of manufacture which, in contrast with conventional methods of manufacturing rare-earth magnets, is able to induce a modified alloy that increases the coercive force at low temperatures (particularly the coercive force in a high-temperature atmosphere) to infiltrate a rare-earth magnet compact, and can thereby produce rare-earth magnets having a high coercive force and also having a relatively high magnetization.

The method of manufacturing' rare-earth magnets according to the invention includes: a first step of producing a compact by subjecting a sintered body, which is formed of a RE—Fe—B main phase having a nanocrystalline structure (where RE is at least one of neodymium and praseodymium) and a grain boundary phase of an RE—X alloy (where X is a metal element) located around the main phase, to hot plastic processing that imparts anisotropy; and a second step of producing a rare-earth magnet by melting a RE—Y—Z alloy which increases the coercive force of the compact (where Y is a transition metal element and Z is a heavy rare-earth element), together with the grain boundary phase, and liquid-phase infiltrating the RE—Y—Z alloy melt from a surface of the compact.

In the manufacturing method of the invention, a modified alloy having a melting point that is much lower than conventional modified alloys is used and the grain boundary phase and the modified alloy are melted together, thereby liquid-phase infiltrating a melt of the modified alloy into the grain boundary phase while the latter is in a molten state. As a result, this is a method for manufacturing nanocrystalline magnets having, in particular, a high coercive force in a high-temperature atmosphere (e.g., 150° C. to 200° C.), and also having a relatively high magnetization.

First, a melt of the composition making up the rare-earth magnet is liquid quenched, producing a rapidly cooled ribbon composed of fine crystal grains. This is then loaded into a die and sintered under the application of pressure with a punch and thereby consolidated, giving an isotropic sintered body composed of an RE—Fe—B main phase (wherein RE is at least one of neodymium (Nd) and praseodymium (Pr), and is more specifically one, two or more from among Nd, Pr and Nd—Pr) having nanocrystalline structure and a grain boundary phase composed of an RE—X alloy (wherein X is a metal element) around the main phase.

Next, the sintered body is subjected to hot plastic working so as to impart anisotropy, thereby giving a compact. In such hot plastic working, in addition to the working temperature and the working time, adjustment of the plastic strain rate is also an important parameter.

The RE—X alloy making up the grain boundary phase of this compact differs also according to the ingredients of the main phase. For example, in cases where RE is Nd, the RE—X alloy may be an alloy of Nd with at least one from among cobalt (Co), iron (Fe) and gallium (Ga), such as any one of Nd—Co, Nd—Fe, Nd—Ga, Nd—Co—Fe and Nd—Co—Fe—Ga, or a mixture of two or more thereof, and is in an Nd-rich state. In cases where RE is Pr, the RE—X alloy may be in a Pr-rich state similarly to the cases where RE is Nd.

The inventors have identified the melting points of Nd—Co, Nd—Fe, Nd—Ga, Nd—Co—Fe and Nd—Co—Fe—Ga, and of grain boundary phases where these are present in admixture as being in the vicinity of about 600° C. (because there is some variability due to the ingredients and the ratios thereof, in the range of about 550° C. to about 650° C.). Moreover, it is preferable for the grain size of the main phase to be in the range of 50 nm to 300 nm. More preferably, the average grain size of the main phase is about 200 nm. This is based on the finding by the inventors that, in cases where a main phase having such a grain size range is employed in nanocrystalline magnets, the grain size does not increase.

Next, the grain boundary phase making up this compact is melted, thus causing a RE—Y—Z alloy (wherein Y is a transition metal element, and Z is a heavy rare-earth element), which is a modified alloy, to liquid-phase infiltrate the compact from the surface thereof. The RE—Y—Z alloy melt thereby infiltrates into the molten-state grain boundary phase of the compact and, while giving rise to structural changes at the interior of the compact, produces a rare-earth magnet having an increased coercive force.

By selecting, as the molten-state RE—Y—Z alloy to be liquid-phase infiltrated from the surface of the compact into the liquid-state grain boundary phase, a Nd alloy having a melting point similar to that of the grain boundary phase, a melt of the Nd alloy in the range of about 600° C. to about 650° C. infiltrates into the molten-state grain boundary phase. As a result, compared to a case in which a Dy—Cu alloy or the like is solid-phase diffused within the grain boundary phase, the diffusion efficiency and rate of diffusion rise markedly, enabling diffusion of the modified alloy to be achieved in a short time.

It was discovered that, by using a Re—Y—Z alloy (wherein Y is a transition metal element, and Z is a heavy rare-earth element), the melting point can be greatly lowered compared with cases in which a heavy rare-earth element such as Dy is diffused and infiltrated alone as in conventional manufacturing methods, and cases in which an alloy of a transition metal element and a heavy rare-earth element, such as a Dy—Cu alloy, is diffused and infiltrated.

“Transition metal elements” that may be employed include any one from among, for example, Cu, Fe, Mn, Co, Ni, Zn and Ti. “Heavy rare-earth elements” that may be employed include any one from among, for example, Dy, Tb and Ho.

By using a RE—Y—Z alloy (wherein Y is a transition metal element, and Z is a heavy rare-earth element), compared to cases up until now in which a Dy alloy or the like is diffused and infiltrated in an high-temperature atmosphere of at least 1000° C., infiltration of a modified alloy can be carried out under much lower temperature conditions of about 600° C. As a result, coarsening of the main phase (crystalline grains) can be suppressed, which also contributes to an increase in the coercive force. In particular, infiltration of a modified alloy under temperature conditions of about 600° C. may also be regarded as desirable because nanocrystalline magnets, unlike sintered magnets, undergo pronounced coarsening of the crystal grains when placed for about 10 minutes in a high-temperature atmosphere of about 800° C. Even in cases where a 70Dy-30Cu alloy is used, because this has a melting point of 790° C., high-temperature treatment of about 800° C. is required, making it impossible to suppress coarsening of the crystal grains.

By way of illustration, when a Nd—Cu—Dy alloy is used, although the melting point of the alloy differs with the ingredient ratio therein (e.g., the melting point of the alloy 60Nd-30Cu-10Dy is 533° C., and the melting point of the alloy 50Nd-30Cu-20Dy is 576° C.), such modified alloys have melting points which are generally less than 600° C.; hence, the alloy has a low melting point which is similar to that of the grain boundary phase.

With regard to the change in structure at the interior of the compact, in a compact that has been subjected to hot plastic working, the structure is often in a state where the crystal grains have a flattened shape which is perpendicular to the direction of orientation, and the grain boundaries substantially parallel to the axis of anisotropy are curved or bent and tend not to be composed of specific planes. By contrast, when a melt of the modified alloy undergoes liquid-phase infiltration into the molten-state grain boundary phase, as time passes, the interfaces of the crystal grains become distinct, magnetic decoupling between the crystal grains proceeds, and the coercive force increases. However, in the course of such a change in structure, the sides of the crystal grains parallel to the axis of anisotropy are not yet specific planes.

At a stage where the change in structure at the interior of the compact is complete, the crystal grains have a shape such that the planar shape as seen from a direction perpendicular to the axis of anisotropy becomes rectangular or a shape that is approximately rectangular, and the surfaces of the crystal grain become a polyhedron (a hexahedron (rectangular prism), an octahedron, or a solid similar thereto) surrounded by low-index (Miller index) planes. For example, in the case of a hexahedron, the inventors have determined that the axis of orientation is formed in the (001) plane (the direction of easy magnetization (c axis) being the top and bottom sides of the hexahedron), and the lateral sides are formed of (110), (100) or plane indices similar thereto.

As can be appreciated from the foregoing description, the inventive method of manufacturing rare-earth magnets uses a RE—Y—Z alloy (wherein Y is a transition metal element, and Z is a heavy rare-earth element), which is a low-melting modified alloy, to liquid-phase infiltrate a modified alloy melt into the molten-state grain boundary phase of a compact obtained by subjecting a sintered body composed of a RE—Fe—B main phase (wherein RE is at least, one of Nd and Pr) having a nanocrystalline structure and a grain boundary phase of RE—X alloy located around the main phase to hot plastic working. As a result, coarsening of the nanocrystalline grains making up the main phase can be suppressed, enabling magnetic decoupling between the nanocrystalline grains to be precisely achieved in the modified grain boundary phase, and thus making it possible to manufacture rare-earth magnets which also have a good magnetization.

### BRIEF DESCRIPTION. OF THE DRAWINGS

The features, advantages, and technical and industrial significance of this invention will be described in the following detailed description of example embodiments of the invention with reference to the accompanying drawings, in which like numerals denote like elements, and wherein:

FIGS. 1A, B and C are schematic diagrams illustrating, in the order FIG. 1A, 1B and 1C, the first step in an embodiment of the inventive method of manufacturing rare-earth magnets;

FIG. 2A is a diagram depicting the microstructure of a sintered body obtained via the step shown in FIG. 1B, and FIG. 2B is a diagram depicting the microstructure of a compact in FIG. 1C;

FIG. 3A is a diagram illustrating the second step in an embodiment of the inventive method of manufacturing rare-earth magnets, FIG. 3B is a diagram depicting the microstructure of a rare-earth magnet during modification of the structure with a modified alloy, and FIG. 3C is a diagram depicting the microstructure of a rare-earth magnet in which modification of the structure with a modified alloy is complete; and

FIG. 4 is a graph showing the experimental results relating to magnetization and coercive force before and after the diffusion of a modified alloy.

### DETAILED DESCRIPTION OF EMBODIMENTS

Embodiments of the inventive method of manufacturing rare-earth magnets are described below in conjunction with the attached diagrams.

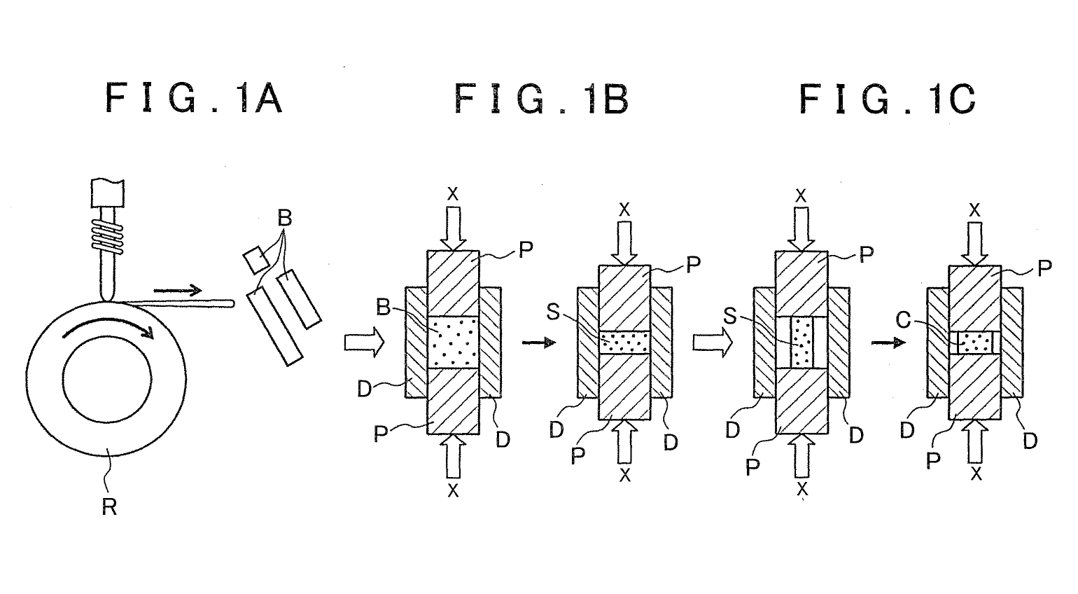

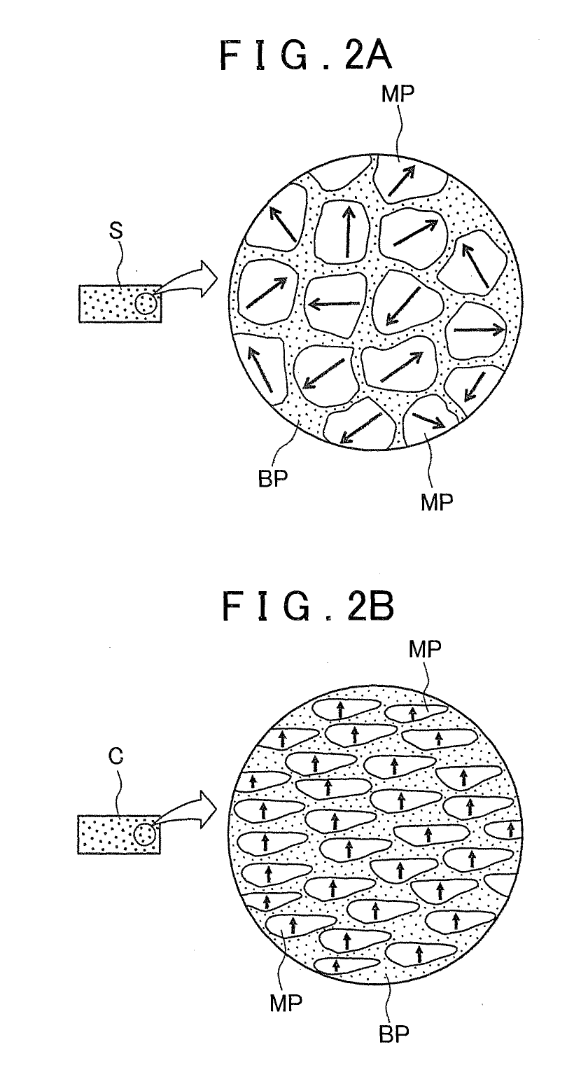

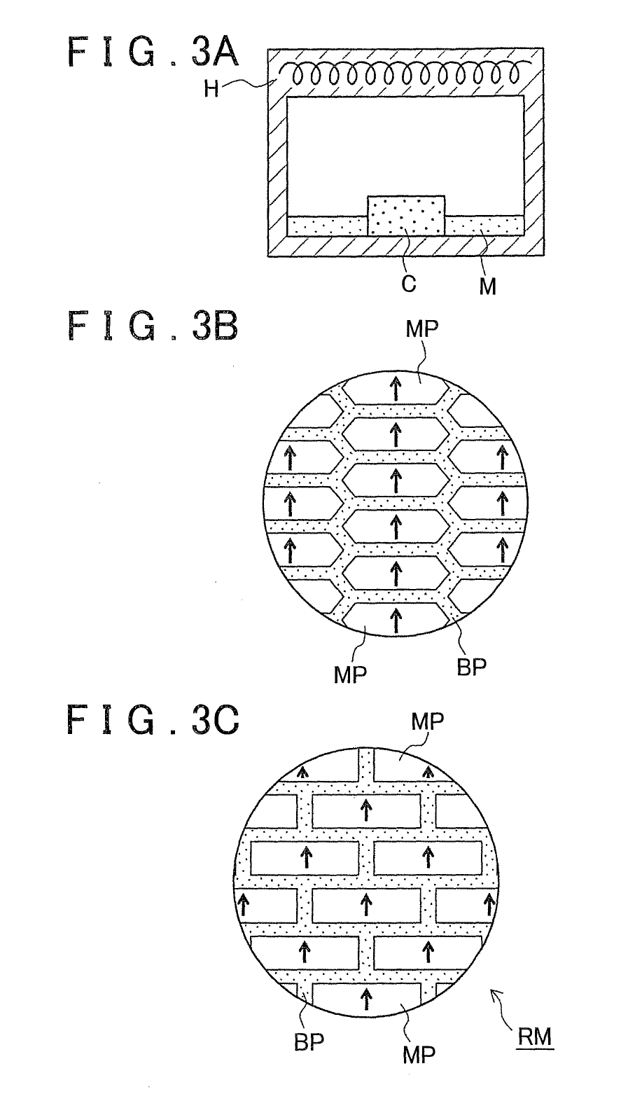

FIGS. 1A, 1B and 1C are schematic diagrams illustrating the first step in an embodiment of the inventive method of manufacturing a rare-earth magnet, and FIG. 3A is a diagram illustrating the second step in the inventive method of manufacturing rare-earth magnets. Also, FIG. 2A is a diagram depicting the microstructure of the sintered body shown in FIG. 1B, and FIG. 2B is a diagram depicting the microstructure of the compact in FIG. 1C. In addition, FIG. 3B is a diagram depicting the microstructure of a rare-earth magnet during modification of the structure with a modified alloy, and FIG. 3C is a diagram depicting the microstructure of a rare-earth magnet in which modification of the structure with a modified alloy is complete.

As shown in FIG. 1A, an alloy ingot is high-frequency induction melted by a single-roll melt spinning process in a furnace (not shown) under a reduced-pressure (50 kPa or below) argon gas atmosphere. Next, a rapidly cooled ribbon B is produced by spraying a melt having a structure that imparts this rare-earth magnet onto a copper roll R, and the ribbon B is coarsely ground.

As shown in FIG. 1B, the coarsely ground rapidly cooled ribbon B is loaded into a cavity defined by a carbide die D and a carbide punch P which slides through a hollow interior of the die D, then is heated, while applying pressure thereto with the carbide punch P, by passing an electrical current therethrough in the direction of pressure application (X direction). This results in the production of a sintered body S composed of a Nd—Fe—B main phase having a nanocrystalline structure (grain size, about 50 nm to about 200 nm) and a Nd—X alloy (wherein X is a metal element) located around the main phase.

Here, the Nd—X alloy making up the grain boundary phase is in a Nd-rich state and is composed of an alloy of at least one from among Co, Fe and Ga, such as any one of Nd—Co, Nd—Fe, Nd—Ga, Nd—Co—Fe and Nd—Co—Fe—Ga, or is a mixture of two or more thereof

As shown in FIG. 2A, the sintered body S exhibits an isotropic crystal structure in which the grain boundary phase BP fills the gaps between the nanocrystalline grains MP (main phase). Hence, to impart anisotropy to this sintered body S, as shown in FIG. 1C, a carbide punch P is brought into direct contact with the endfaces in the longitudinal direction (in FIG. 1B, the horizontal direction serves as the lengthwise direction) of the sintered body S, and hot plastic working is carried out while pressing (in the X direction) with the carbide punch P. As shown in FIG. 2B, a compact C with a crystal structure having anisotropic nanocrystalline grains MP is thereby produced (the above operation serves as the first step).

When the working ratio (compressibility) due to hot plastic working is large, such as in cases where the compressibility is about 10% or more, this may be called “hot intensive working” or simply “intensive working.”

In the crystal structure of the compact C shown in FIG. 2B, the nanocrystalline grains MP have a flattened shape, with the interfaces that are substantially parallel with the axis of anisotropy being curved or bent and not composed of specific planes.

Next, as shown in FIG. 3A, the compact C that has been produced is placed inside a high-temperature furnace H equipped with an internal heater, a modified alloy M composed of Nd—Y—Z alloy (wherein Y is a transition metal element, and Z is a heavy rare-earth element) is brought into contact with the compact C, and the furnace interior is placed under a high-temperature atmosphere.

Here, any one from among Cu, Fe, Mn, Co, Ni, Zn and Ti may be employed as the transition metal element Y, and any one from among Dy, Tb and Ho may be employed as the heavy rare-earth metal element Z. Illustrative examples include Nd—Cu—Dy alloys and Nd—Cu—Tb alloys.

The melting point of the grain boundary phase composed of Nd—Co, Nd—Fe, Nd—Ga, Nd—Co—Fe, Nd—Co—Fe—Ga or a mixture thereof varies somewhat with the ingredients and the proportions thereof, but is generally in the vicinity of 600° C. (taking this variability into account, the range is from about 550° C. to about 650° C.).

In cases where a Nd—Cu—Dy alloy or a Nd—Cu—Tb alloy is used as the modified alloy, because these have melting points are not higher than 600° C. (from about 530° C. to about 580° C.), the melting points are about the same as or lower than the melting point of the grain boundary phase BP. Therefore, by setting the interior of the high-temperature furnace H to a temperature of 600° C. to 650° C., the grain boundary phase BP melts, and the Nd—Cu—Dy alloy or Nd—Cu—Tb alloy serving as the modified alloy also melts.

The molten Nd—Cu—Dy alloy or Nd—Cu—Tb alloy melt then liquid-phase infiltrates into the grain boundary phase BP which is in a molten state.

Because the modified alloy melt liquid-phase infiltrates in this manner into the molten-state grain boundary phase BP, the diffusion efficiency and diffusion rate are far better than in cases where a Dy—Cu alloy or the like is solid-phase diffused into the grain boundary phase as in conventional manufacturing methods, enabling diffusion of the modified alloy to be achieved in a short time.

When the modified alloy melt is liquid-phase infiltrated into the grain boundary phase and a certain amount of time passes by, the crystalline structure of the compact C shown in FIG. 2B changes, the interfaces of the grains MP become distinct as shown in FIG. 3B, and magnetic decoupling of grains MP proceeds, resulting in an increase in the coercive force. However, in the course of structural modification by the modified alloy shown in FIG. 3B, interfaces that are substantially parallel to the axis of anisotropy do not form (the interfaces are not composed of specific planes).

At a stage where modification by the modified alloy has proceeded to a sufficient degree, interfaces substantially parallel to the axis of anisotropy (i.e., specific planes) form as shown in FIG. 3C, and a rare-earth magnet RM in which the shape of the grains MP as seen from a direction orthogonal to the axis of anisotropy (the direction in which FIG. 3C is viewed) is rectangular or exhibits a shape that is approximately rectangular.

In rare-earth magnets thus obtained by a manufacturing method according to the embodiments of the invention, owing to the use of a compact obtained by carrying out hot plastic working so as to impart anisotropicity to the sintered body and owing also to the liquid-phase infiltration of a modified alloy melt composed of a Nd—Y—Z alloy (wherein Y is a transition metal element, and Z is a heavy rare-earth element) into a molten-state grain boundary phase, it appears that residual strain which arises due to hot plastic working is eliminated by contact with the modified alloy melt, and also that the coercive force is improved by the reduction in size of the crystal grains and the promotion of magnetic decoupling between the crystal grains.

Moreover, because a modified alloy having a melting point which is about the same as or lower than the melting point of the grain boundary phase is used, by melting both the grain boundary phase and the modified alloy at the relatively low temperature of about 600° C. to 650° C., coarsening of the nanocrystalline grains is suppressed, which also contributes to an improved coercive force.

The inventors conducted an experiment in which they produced rare-earth magnets that are nanocrystalline magnets by employing the above-described manufacturing method of the invention and they similarly produced rare-earth magnets using conventional modified alloys as the modified alloy that is infiltrated into the grain boundary phase. They then measured the magnetization and coercive force of each of the specimens, both before and after diffusion of the modified alloy, and compared the results.

The method of manufacturing specimens in the embodiment is described.

First, using a rapidly quenched Nd-Fe-B-based magnetic powder (grain size, 200 nm or less, Nd30 wt %, Fe64 wt %, B0.9 wt %) that is commercially available, the powder was pressure sintered within a forming mold at a holding temperature of 600° C. and a holding pressure of 50 MPa for a holding time of 5 minutes, thereby forming a sintered body.

The sintered body thus formed was plastic worked at a working temperature of 750° C., a working ratio of 70% and a strain rate of 1/s, thereby producing a compact prior to diffusion of the modified alloy.

The top and bottom sides of the compact were coated with a modified alloy, and the coated compact was placed in a titanium vessel. The interior of the vessel was evacuated or placed under an argon atmosphere, and diffusion/infiltration of the modified alloy was carried out for 2 hours under the conditions in Table 1 below, thereby producing rare-earth magnets.

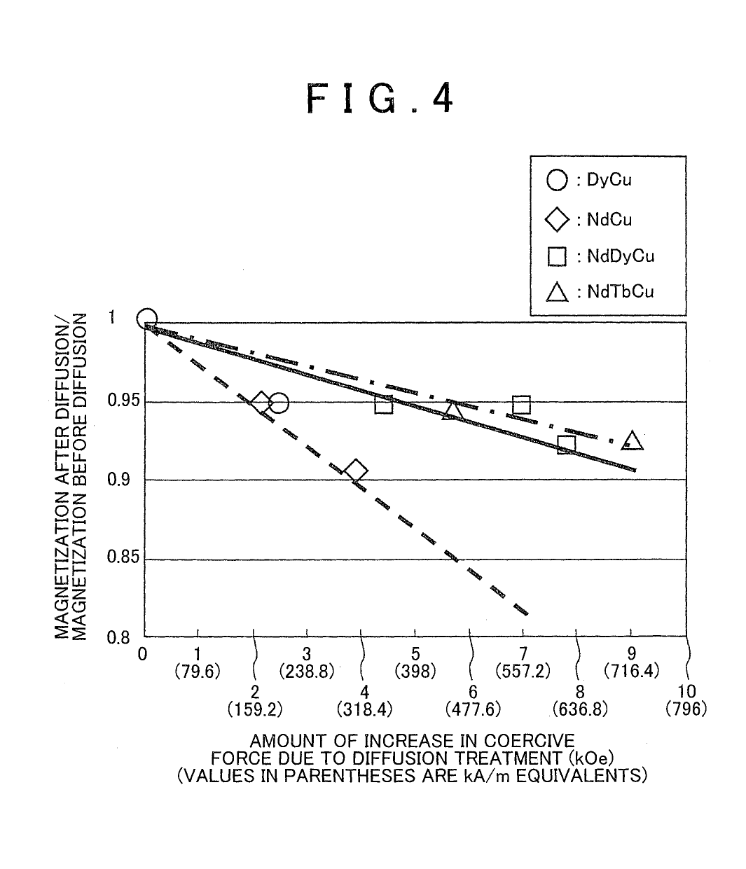

The specimens thus produced were each magnetically measured using a pulsed excitation-type magnetic property measurement system, and the magnetization ratio before and after diffusion and the amount of increase in coercive force before and after diffusion were measured. Those results are shown in Table 2 below and in FIG. 4.

TABLE 1

| | | | | Treat- |
|---|---|---|---|---|
| | Modified | Modified | Modified | ment |
| | alloy | alloy | alloy | temper- |
| | composition | melting point | concentration | ature |
| | (at %) | (° C.) | (wt %) | (° C.) |
| Example 1 | 60Nd30Cu10Dy | 533 | 5 | 650 |
| Example 2 | 60Nd30Cu10Dy | 533 | 10 | 650 |
| Example 3 | 50Nd30Cu20Dy | 576 | 5 | 650 |
| Example 4 | 60Nd30Cu10Tb | 524 | 5 | 650 |
| Example 5 | 60Nd30Cu10Tb | 524 | 10 | 650 |
| Comp. Ex. 1 | 70Nd30Cu | 490 | 5 | 650 |
| Comp. Ex. 2 | 70Nd30Cu | 490 | 10 | 650 |
| Comp. Ex. 3 | 70Dy30Cu | 790 | 2 | 650 |
| Comp. Ex. 4 | 70Dy30Cu | 790 | 2 | 800 |

TABLE 2

| | Magnetization after diffusion/ | Amount of increase |
|---|---|---|
| | Magnetization before diffusion | in coercive force (kOe) |
| | (Magnetization ratio | (values in parentheses |
| | before/after diffusion) | are kA/m equivalents) |
| Example 1 | 0.95 | 4.2 (334.3) |
| Example 2 | 0.92 | 7.5 (597) |
| Example 3 | 0.95 | 7 (557.2) |
| Example 4 | 0.95 | 5.5 (437.8) |
| Example 5 | 0.93 | 8.8 (700.5) |
| Comp. Ex. 1 | 0.95 | 2 (159.2) |
| Comp Ex. 2 | 0.9 | 4.3 (342.3) |
| Comp. Ex. 3 | 1 | 0 (no diffusion) |
| Comp. Ex. 4 | 0.95 | 2 (159.2) |

It can be ascertained from Table 2 and FIG. 4 that, in each of Examples 1 to 5, roughening of the grains was being suppressed (though each of them includes some rough grains of which the grain sizes are over 500nm, the grain size in each case was about 200 nm to 300nm or less), and the coercive force rose while a decrease in magnetization was being suppressed.

As for the comparative examples, in Comparative Examples 1 and 2, it was possible to increase the coercive force by the diffusion of a Nd—Cu alloy (the coercive force in Comparative Example 2 was about the same as that in Example 1). In Comparative Example 2 in particular, the decrease in magnetization was pronounced.

Turning to Comparative Examples 3 and 4, in the case of Comparative Example 3, wherein the working temperature during diffusion of the Dy—Cu alloy was low, it was found that the modified alloy did not melt, modified alloy did not sufficiently diffuse into the grain boundary phase, and there was substantially no rise in the coercive force. In the case of Comparative Example 4, wherein high-temperature working was carried out, it was found that the crystal grains ended up coarsening to a size of 1 μm or more, the structure broke down, and the rise in coercive force was small.

From these experimental results, it was apparent that coarsening of the grains is suppressed by using a Nd—Cu—Dy alloy or a Nd—Cu—Tb alloy having a melting point which is about the same as that of the boundary phase or lower, and liquid-phase infiltrating a melt of the modified alloy into the boundary phase while the latter is in a molten state. Moreover, it was demonstrated that when the grains are decoupled with an alloy such as Nd—Cu, by raising the level also of Dy or Tb where these types of alloys are concentrated, the decoupling ability between the grains is enhanced, resulting in an increased coercive force while suppressing a decrease in magnetization.

Embodiments of the invention have been described above in detail in conjunction with the attached drawings. However, the specific structure of the invention is not limited to these embodiments and various design modifications are possible insofar as they do not depart from the gist of the invention.

1. A method of manufacturing rare-earth magnets, the method comprising:
a first step of producing a compact by subjecting a sintered body, which is formed of a RE—Fe—B main phase having a nanocrystalline structure and a grain boundary phase of an RE—X alloy located around the main phase, to hot plastic processing that imparts anisotropy; and
a second step of producing a rare-earth magnet by melting a RE—Y—Z alloy which increases the coercive force of the compact together with the grain boundary phase, and liquid-phase infiltrating the RE—Y—Z alloy melt from a surface of the compact,
wherein RE is at least one of neodymium and praseodymium,
X is a metal element,
Y is a transition metal element,
Z is a heavy rare-earth element, and
the main phase includes crystals of which grain sizes are in a range of 50 nm to 300 nm.

2. The rare-earth magnet manufacturing method according to claim 1, wherein a Nd—Cu—Dy alloy or a Nd—Cu—Tb alloy is used as the RE—Y—Z alloy.

3. The rare-earth magnet manufacturing method according to claim 1, wherein, in the second step, the RE—Y—Z alloy melt is liquid-phase infiltrated at a temperature of 550° C. to 650° C.

4. (canceled)
